(19) United States
(12) Patent Application Publication
(10) Pub. No.: US 2009/0055870 A1
(43) Pub. Date: Feb. 26, 2009

(54) Digital Broadcast Receiving Apparatus

(75) Inventor: Tatsuto Horibe, Hyogo (JP)

Correspondence Address: RATNERPRESTIA, P.O. BOX 980, VALLEY FORGE, PA, 19482, US

(73) Assignee: PANASONIC CORPORATION, Osaka (JP)

(21) Appl. No.: 11/910,811

(22) PCT Filed: Mar. 23, 2006
(86) PCT No.: PCT/JP2006/305780

§ 371 Date: Oct. 5, 2007

(30) Foreign Application Priority Data
Apr. 8, 2005 (JP) 2005-112037

(51) Int. Cl. H04N 5/445; H04N 7/173

(52) U.S. Cl. 725/46; 725/131

(57) ABSTRACT

A digital broadcast receiving apparatus that utilizes an unused tuner effectively to shorten channel selection time is disclosed. The apparatus is equipped with plural tuners that receive digital broadcast waves; a TS processing unit capable of processing at least two TSes demodulated by the tuner; a service information acquiring unit that extracts service information from the TS processing unit; a data contents acquiring unit that caches data contents; an audio and visual output control unit capable of processing plural audio and visual data simultaneously or alternately by switching; and a channel selection control unit that predicts a channel that the user is likely to select next time and preliminarily performs predicted channel selection process using a tuner currently not selected.

### TECHNICAL FIELD

The present invention relates to a method of selecting a channel in a digital broadcast receiving apparatus having plural tuners.

### BACKGROUND ART

In a broadcast receiving apparatus with plural tuners incorporated therein, a description is made for the conventional makeup related to a selection method in which a tuner currently not selected is effectively used. Conventional makeup where the presence or absence of a synchronizing signal is checked using an unused tuner and is stored along with channel information to shorten channel selection time is disclosed in Japanese Patent Unexamined Publication No. 2004-7318, for example. Conventional makeup where a channel is switched after synchronizing using an unused tuner in channel selection to prevent synchronism from being disturbed is disclosed in Japanese Patent Unexamined Publication No. H07-283965, for example.

Meanwhile, many broadcast receiving apparatus with plural tuners incorporated therein have appeared for double-screened display, picture-in-picture method, and recording function of another program on a different channel incorporated in a video recording device. Under present circumstances, however, plural tuners are limitedly used with most of programs to be viewed determined by regular channel selection method.

In such a situation, digital broadcast is becoming a mainstream nowadays. The channel selection process in a digital broadcast receiving apparatus is diverse and can require processing time, unlike analog broadcast receiving. The process includes terminating the data contents of a selected channel before channel switching, switching a tuner, process of acquiring program-specific information (described as PSI hereinafter), descrambling, decoding audio and visual (described as AV hereinafter), acquiring the data contents of a next-selected channel at channel switching.

The above-described conventional makeup does not include a useful method for shortening channel selection time of digital broadcast requiring substantially long processing time in a digital broadcast receiving apparatus including plural tuners.

### SUMMARY OF THE INVENTION

The present invention provides a digital broadcast receiving apparatus that uses an unused tuner effectively to shorten channel selection time of digital broadcast requiring long processing time.

A digital broadcast receiving apparatus of the present invention includes plural tuners; a transport stream (described as TS hereinafter) processing unit or a TS processing unit group; a service information (described as SI hereinafter)/program-specific information (described as PSI hereinafter) acquiring unit; a data contents acquiring unit; an audio and visual output control unit; and a channel selection control unit. The tuners receive digital broadcast waves. The TS processing unit can process at least two TSes demodulated by a tuner.

The SI/PSI acquiring unit extracts SI from the TS processing unit. The data contents acquiring unit caches data contents. The audio and visual output control unit can process plural audio and visual data simultaneously or alternately by switching. The channel selection control unit selects one from among the plural tuners on the basis of user's an instruction of channel selection to perform channel selection process. Further, the channel selection control unit preliminarily performs predicted channel selection process that preliminarily predicts a channel that the user is likely to select next time and performs channel selection process using a tuner currently not selected out of the plural tuners. This process enables shortening channel selection time of digital broadcast requiring substantially long processing time utilizing a currently unused tuner.

The digital broadcast receiving apparatus of the present invention may further include a statistical data detecting unit that detects statistical data related to reception of digital broadcast waves, and the channel selection control unit may perform predicted channel selection process on the basis of statistical data detected by the statistical data detecting unit. Consequently, predicting and specifying a next selected channel on the basis of statistical data (e.g. after the channel is changed to a higher number, the channel is often changed to a further higher one) improve the prediction hit rate to shorten channel selection time of digital broadcast.

The digital broadcast receiving apparatus of the present invention may further include a viewing pattern detecting unit that detects user's viewing patterns, and the channel selection control unit may perform predicted channel selection process on the basis of user's viewing patterns detected by the viewing pattern detecting unit. Consequently, predicting and specifying a next selected channel on the basis of correlation between the time frame and the day of the week, and a channel to be viewed, for example, improve the prediction hit rate to shorten channel selection time of digital broadcast.

The digital broadcast receiving apparatus of the present invention may further include a predicted channel selecting operation setting unit and a predicted channel selecting operation setting detecting unit. The predicted channel selecting operation setting unit sets the type of operation in which the user performs predicted channel selection. The predicted channel selecting operation setting detecting unit detects channel selecting operation predicted by the type of predicted channel selecting operation set by the predicted channel selecting operation setting unit. The channel selection control unit may perform predicted channel selection process on the basis of channel selecting operation predicted, detected by the selection operation setting detecting unit. Consequently, always having the user select a channel for predicted channel selection, such as a channel frequently viewed by the user or a channel viewed immediately before, improves the prediction hit rate to shorten channel selection time of digital broadcast.

The digital broadcast receiving apparatus of the present invention may further include a channel selection menu display unit and a cursor position detecting unit. The channel selection menu display unit displays a menu for channel selection. The cursor position detecting unit detects the position of a cursor that moves on the menu for channel selection. The channel selection control unit may perform predicted channel selection process on the basis of the cursor position detected by the cursor position detecting unit. Consequently, performing predicted channel selection on the basis of the cursor position while displaying a channel selection menu in an application that implements channel selection from a menu such as an electronic program guide (described as EPG hereinafter) improves the prediction hit rate to shorten channel selection time of digital broadcast.

### BRIEF DESCRIPTION OF DRAWINGS

FIG. 1 is a block diagram illustrating the makeup of a digital broadcast receiving apparatus according to the first embodiment of the present invention.

FIG. 2 is a block diagram illustrating the makeup of a digital broadcast receiving apparatus according to the second embodiment of the present invention.

FIG. 3 is a block diagram illustrating the makeup of a digital broadcast receiving apparatus according to the third embodiment of the present invention.

FIG. 4 is a block diagram illustrating the makeup of a digital broadcast receiving apparatus according to the fourth embodiment of the present invention.

FIG. 5 is a block diagram illustrating the makeup of a digital broadcast receiving apparatus according to the fifth embodiment of the present invention.

### REFERENCE MARKS IN THE DRAWINGS

101₁ through 101ₙ Tuner
103 TS processing unit
104 Audio and visual output control unit
105 SI/PSI acquiring unit
106 Data contents acquiring unit
107 Channel selection control unit
108 Digital broadcast receiving apparatus
109 Display unit
110 Statistical data detecting unit
111 Viewing pattern detecting unit
112 Predicted channel selecting operation setting unit
113 Predicted channel selecting operation setting detecting unit
114 Channel selection menu display unit
115 Cursor position detecting unit

### DETAILED DESCRIPTION OF PREFERRED EMBODIMENTS

Hereinafter, a description is made for exemplary embodiments of the present invention, with reference to the related drawings.

### First Exemplary Embodiment

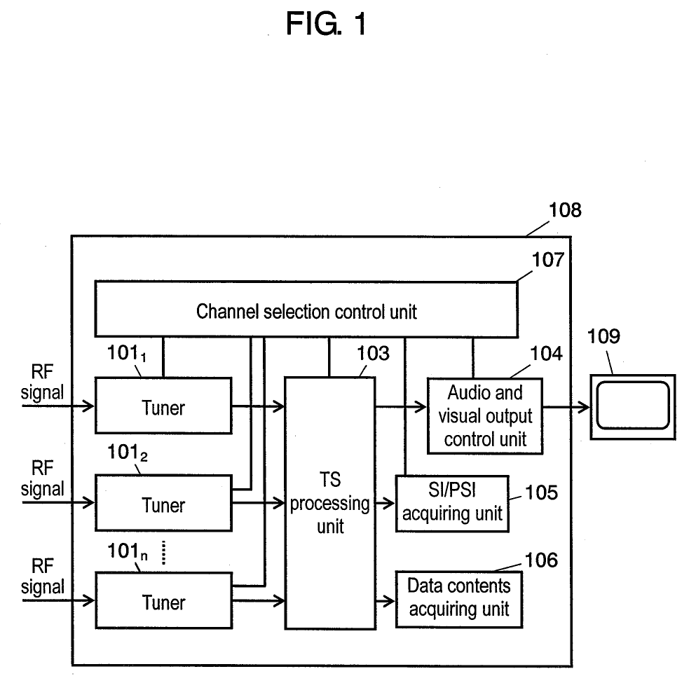

FIG. 1 is a block diagram illustrating the makeup of a digital broadcast receiving apparatus according to the first embodiment of the present invention. In FIG. 1, digital broadcast receiving apparatus 108 is equipped with n (n is a natural number 2 or larger) tuners 101₁ through 101ₙ, TS processing unit 103, SI/PSI acquiring unit 105, data contents acquiring unit 106, audio and visual output control unit 104, and channel selection control unit 107. Tuners 101₁ through 101ₙ are supplied with a radio-frequency (described as RF hereinafter) signal to receive digital broadcast waves. TS processing unit 103 processes at least two TSes demodulated by tuner 101₁ to 101ₙ.

SI/PSI acquiring unit 105 extracts and acquires service information from the TS processing unit. Data contents acquiring unit 106 caches data contents. Audio and visual output control unit 104 processes plural audio and visual data simultaneously or alternately by switching to output to display unit 109. Channel selection control unit 107 selects tuner 101₁, one of plural tuners 101₁ through 101ₙ, on the basis of user's an instruction of channel selection, to perform channel selection process. Further, channel selection control unit 107 preliminarily predicts a channel that the user is likely to select next time and preliminarily performs predicted channel selection process using a tuner currently not selected.

A user is assumed to be viewing channel A through tuner 101₁. At this moment, channel selection control unit 107 makes tuner 101₂ not selected tune predicted channel B, for example and stands by making SI/PSI acquiring unit 105 and data contents acquiring unit 106 operate simultaneously. After that, if the user directs to switch to channel B as predicted, unit 107 controls TS processing unit 103 to connect a signal from tuner 101₂ to audio and visual output control unit 104. Controlling audio and visual output control unit 104 in reference to PSI information acquired by SI/PSI acquiring unit 105 implements switching from channel A to channel B. If a channel different from that predicted is selected, tuner 101₁ currently selected is used to select a channel.

As described above, channel selection control unit 107 predicts a channel that the user is likely to select next time and uses tuner 101₂ not selected to preliminarily perform predicted channel selection process, thereby improving the process speed for channel selection. How to predict a channel that the user is likely to select next time is described in each exemplary embodiment hereinafter.

### Second Exemplary Embodiment

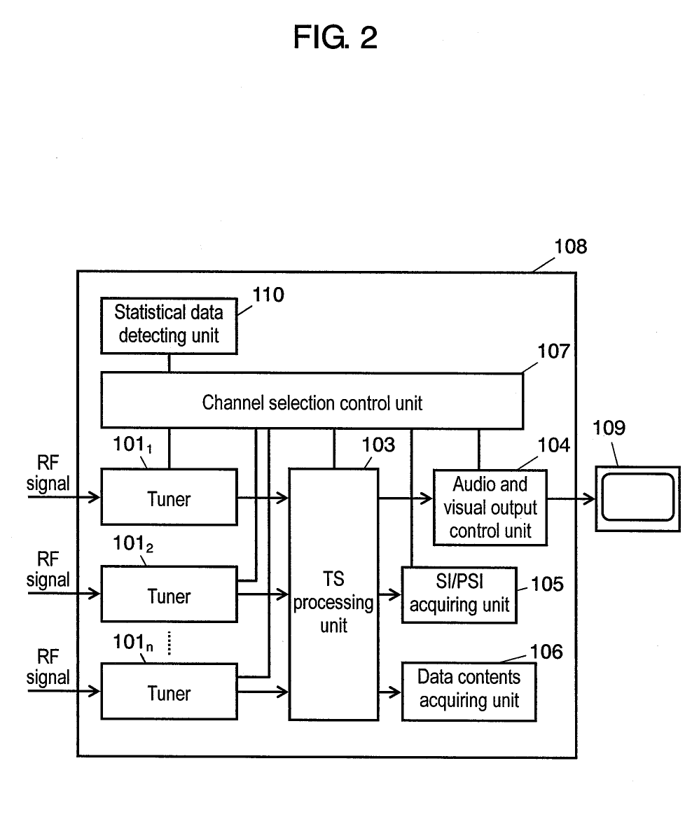

FIG. 2 is a block diagram illustrating the makeup of a digital broadcast receiving apparatus according to the second embodiment of the present invention. In FIG. 2, a component same as that in FIG. 1 is given the same reference mark to omit its description. In this embodiment, statistical data detecting unit 110 is provided that detects statistical data related to reception of digital broadcast waves. In a digital broadcast receiving apparatus with the above-described makeup, a description is made using FIG. 2 for how to increase the speed of zapping (e.g. changing the channel to a higher number continuously while commercial messages are broadcast).

The assumption is made that this is a digital broadcast receiving apparatus in which the channel changes from channel A to channel B, from channel B to channel C, and from channel C to channel D when the user changes the channel to a higher number while viewing channel A through tuner 101₁. At this moment, if the channel-up button (not shown) is pressed by the user, channel selection control unit 107 controls tuner 101₁ and TS processing unit 103 in order to switch from channel A to channel B, and further controls audio and visual output control unit 104 in reference to PSI information acquired by SI/PSI acquiring unit 105 to perform channel selecting operation.

Further, information indicating that channel selection has been made with the channel-up button is sent to statistical data detecting unit 110. Unit 110 detects relevant statistical data from among those on file and outputs the relevant statistical data to channel selection control unit 107. Channel selection control unit 107 predicts that the channel-up button will be used to next select a channel with a high possibility, for example, on the basis of information obtained from statistical data detecting unit 110. Then, channel selection control unit 107 makes tuner 101₂ tune channel C, and stands by making SI/PSI acquiring unit 105 and data contents acquiring unit 106 operate simultaneously.

After then, if the user further presses the channel-up button as predicted, channel selection control unit 107 controls TS processing unit 103 to output a signal from tuner 101₂ to audio and visual output control unit 104. Moreover, unit 107 controls audio and visual output control unit 104 in reference to PSI information acquired by SI/PSI acquiring unit 105 to implement switching from channel B to channel C. Meanwhile, the channel selection has been made from the channel-up button again, and thus unit 107 makes tuner 101ₙ tune channel D according to information from statistical data detecting unit 110 and makes SI/PSI acquiring unit 105 and data contents acquiring unit 106 operate simultaneously, using the same algorithm described above.

If channel selection is made with operation other than channel up due to wrong prediction, a tuner currently selected is used to select a channel. Consequently, channel selection process for the next channel and predicted channel selection process for the channel after next are performed each time the channel-up button is pressed, thereby improving the process speed for zapping. Zapping with the channel-down button can use the same algorithm.

### Third Exemplary Embodiment

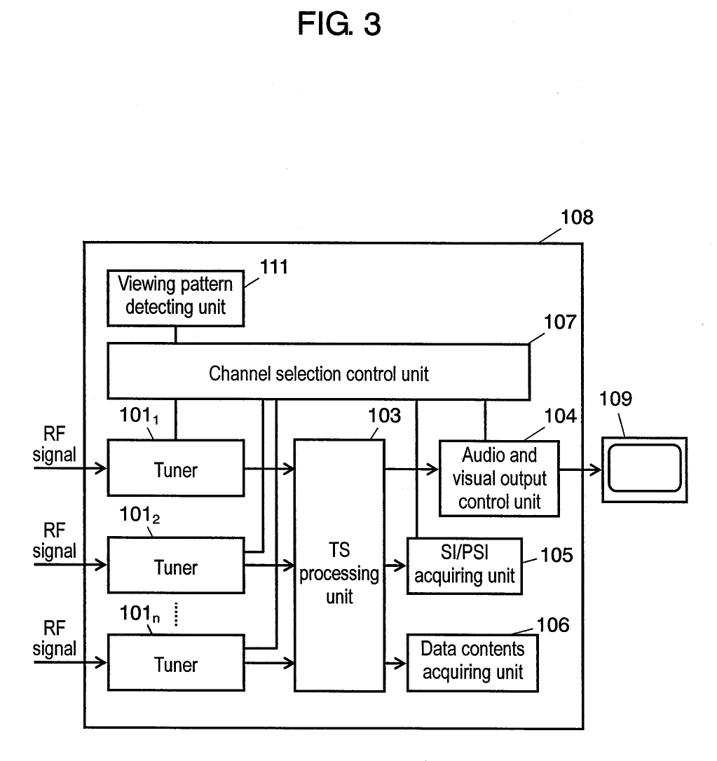

FIG. 3 is a block diagram illustrating the makeup of a digital broadcast receiving apparatus according to the third embodiment of the present invention. In FIG. 3, a component same as that in FIG. 1 is given the same reference mark to omit its description. In this embodiment, viewing pattern detecting unit 111 is provided that detects user's viewing patterns. In a digital broadcast receiving apparatus with the above-described makeup, a description is made using FIG. 3 for a channel selection prediction algorithm based on user's viewing patterns

The assumption is made that the user viewed channel B and is now viewing channel A, through tuner 101₁. Viewing pattern detecting unit 111 stores user's previous viewing information. Specifically, the information includes a viewed channel, a clock time when switching to the channel to be viewed, and a clock time when ending viewing the channel.

Viewing pattern detecting unit 111 can obtain information related to a clock time from the timer unit (not shown) that keeps time. Viewing pattern detecting unit 111 stores viewing information when the user switches the channel while viewing a digital broadcast or when the user ends viewing. With this process, searching viewing data stored allows viewing pattern detecting unit 111 to learn what programs the user viewed in past times.

When viewing pattern detecting unit 111 detects that the user viewed channel B one week before the current clock time, unit 111 outputs the information to channel selection control unit 107. Unit 107 predicts that the channel will be soon switched to channel B with a high possibility, according to information obtained from unit 111. Then, unit 107 makes tuner 101₂ tune channel B and stands by making SI/PSI acquiring unit 105 and data contents acquiring unit 106 operate simultaneously.

After then, if the user switches to channel B as predicted, channel selection control unit 107 controls TS processing unit 103 to output a signal from tuner 101₂ to audio and visual output control unit 104. Further, unit 107 controls audio and visual output control unit 104 in reference to PSI information acquired by SI/PSI acquiring unit 105. Meanwhile, if a channel different from that predicted is selected, tuner 101₁ currently selected is used to select a channel.

If a program viewed by the user one week before the current clock time is not found, viewing pattern detecting unit 111 searches for a program viewed by the user after the clock time one week ago. If viewing information is found, channel selection control unit 107 makes tuner 101₂ tune the relevant channel. For example, if viewing information indicating that the user viewed a program one week before the current clock time is not stored in viewing pattern detecting unit 111, unit 111 searches for a program viewed by the user after the clock time one week ago. Then, information indicating that the user was viewing channel B 10 minutes after the clock time one week ago, for example, unit 111 makes tuner 101₂ tune channel B.

As described above, viewing pattern detecting unit 111 detects correlation between the time frame and the day of the week, and a channel to be viewed according to user's previous viewing patterns, and channel selection control unit 107 performs predicted channel selection in accordance with a program start time. This process allows switching to a user's intended channel instantly.

If a program viewed one week before the current clock time is not found, the reference point for prediction may be changed. For example, if a program viewed one week ago is not found, viewing pattern detecting unit 111 searches for a program viewed one day ago. Then, information indicating that channel B was viewed one day ago is stored in viewing pattern detecting unit 111, tuner 101₂ may be made tune channel B.

User's previous viewing information may include program information in addition to a viewed channel, a clock time when switching to the channel to be viewed, and a clock time when ending viewing the channel. More desirably, detection can be made that a program of the same series as that viewed one week ago will be broadcast, by comparing program information with SI information of the digital broadcast being broadcast. In this case, judgement can be made that a program similar to that viewed one week ago is currently broadcast on the channel viewed one week ago. Consequently, if a program currently being broadcast is different from that viewed one week ago, on the channel viewed one week ago, changing the reference point for prediction is repeated. This process allows a channel that the user is likely to select next time to be predicted more accurately and tuner 101₂ to tune a user's intended channel, thereby enabling immediately switching to the channel upon channel selection by the user.

In this embodiment, the description is made for a case where the reference point for prediction uses one week, but not limited; one month or one day may be used. Further, three or more tuners may be equipped and different reference points for prediction may be set. In FIG. 3, if tuner 101₁ is used to view, the reference point for tuner 101₂ may be set differently from that for tuner 101ₙ. For example. the reference point for tuner 101₂ can be set to one week; tuner 101ₙ, to one day. In this case, if a channel viewed one week before the current clock time is different from that viewed one day before, switching is instantly made to both a channel viewed one week before and that viewed one day before.

### Fourth Exemplary Embodiment

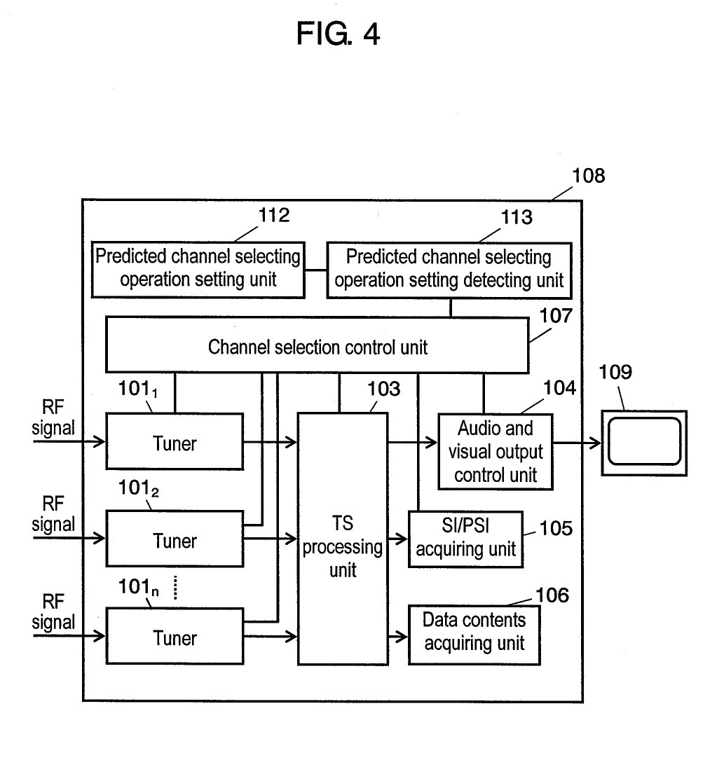

FIG. 4 is a block diagram illustrating the makeup of a digital broadcast receiving apparatus according to the fourth embodiment of the present invention. In FIG. 4, a component same as that in FIG. 1 is given the same reference mark to omit its description. In this embodiment, predicted channel selecting operation setting unit 112 and predicted channel selecting operation setting detecting unit 113 are provided. Unit 112 sets the type of operation for predicted channel selection by the user, such as a user interface. Unit 113 detects operation for predicted channel selection, predicted by the type having been set by unit 112. In a digital broadcast receiving apparatus with the above-described makeup, a description is made using FIG. 4 for a channel selection prediction algorithm based on predicted channel selecting operation detected by channel selecting operation setting detecting unit 113.

The assumption is made that the user is viewing channel A through tuner 101₁, and switches to channel B because channel A starts broadcasting commercial messages such as for advertising the sponsor's products or services. Predicted channel selecting operation setting unit 112 stores the number of tuners for retaining a channel previously selected and that of tuners for performing predicted channel selection described in the third embodiment. In this embodiment, the number of tuners for retaining a channel previously selected is assumed to be one; for predicted channel selection, one.

Channel selection control unit 107 divides the tuners into those for retaining a channel previously selected and those for performing predicted channel selection, on the basis of the number of tuners for retaining, stored in predicted channel selecting operation setting unit 112, and of that for predicted channel selection described in the third embodiment. In this embodiment, while viewing through tuner 101₁, tuner 101₂ is to be that for retaining; tuner 101ₙ, for predicted channel selection.

When receiving a request for selecting channel B from the user, channel selection control unit 107 controls tuner 101₂ and TS processing unit 103, and controls audio and visual output control unit 104 in reference to PSI information acquired by SI/PSI acquiring unit 105, to perform channel selecting operation. Meanwhile, tuner 101₁ retains the current state. When unit 107 receives a request for selecting channel A again after a certain period of time elapses, unit 107 controls TS processing unit 103 to connect a signal from tuner 101₁ to audio and visual output control unit 104, and controls audio and visual output control unit 104 in reference to PSI information acquired by SI/PSI acquiring unit 105. This process shortens channel selection time in a case where the channel is switched to and from channel A and channel B.

The number of tuners for retaining a previous channel can be arbitrarily set, and channels previously set can be cached by the number of tuners for retaining a previous channel. Further, predicted channel selecting operation setting unit 112 enables customizing how to use a tuner in accordance with user's applications. The settings of unit 112 can be updated through the system setting menu, for example. Only when a selection pause button (not shown) provided for making some tuners those for retaining a previous channel is pressed as required, tuner 101₁ to 101ₙ may be operated as that for retaining a previous channel.

More desirably, the transition state of the screen for data broadcast and other states can be retained in such a case. Customized settings from the system setting menu or the like may include setting for caching channel selection information by always performing predicted channel selection process for a favorite (frequently viewed) channel, in addition to setting for caching a channel previously selected as in the above-described example. This can result in smoothly switching to an intended channel.

### Fifth Exemplary Embodiment

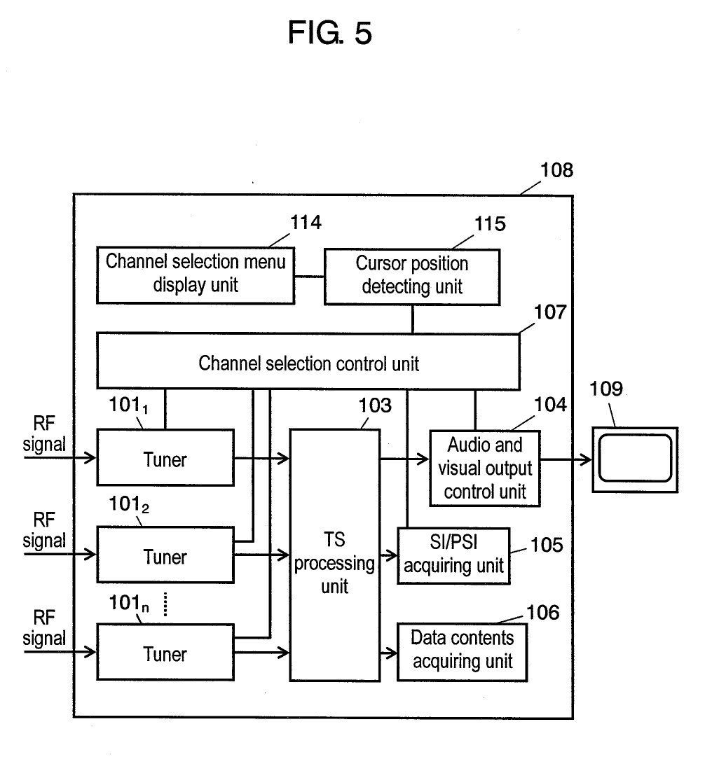

FIG. 5 is a block diagram illustrating the makeup of a digital broadcast receiving apparatus according to the fifth embodiment of the present invention. In FIG. 5, a component same as that in FIG. 1 is given the same reference mark to omit its description. In this embodiment, channel selection menu display unit 114 and cursor position detecting unit 115 are provided. Unit 114 displays a menu for channel selection. Unit 115 detects the cursor position of a channel selected through cursor movement on the display menu of unit 114. In a digital broadcast receiving apparatus with the above-described makeup, a description is made using FIG. 5 for a channel selection prediction algorithm based on the cursor position detected by unit 115.

A description is made for a case where the user is viewing channel A through tuner 101₁. Here, the user becomes concerned about other channel information and presses the EPG button (not shown), for example, to switch to the EPG screen (not shown). The EPG screen is displaying channel A on the subscreen, for example. The user is going to move the cursor to the box for channel B to refer to information on channel B.

At this moment, the subscreen is displaying channel A. Meanwhile, channel selection control unit 107 receives information indicating that the current cursor position is for channel B, from cursor position detecting unit 115. Then, unit 107 makes tuner 101₂ tune channel B and makes SI/PSI acquiring unit 105 and data contents acquiring unit 106 operate simultaneously. Next, when the enter key is pressed by the user while the cursor appears in the box for channel B, unit 107 controls TS processing unit 103, and then connects a signal from tuner 101₂ to audio and visual output control unit 104. Next, unit 107 controls unit 104 in reference to PSI information acquired by SI/PSI acquiring unit 105.

The above process allows improving the operability of channel selection process performed from a menu system such as EPG. Further, selecting a channel in conjunction with the cursor position enables acquiring specific SI information and the like broadcast only on that channel to reflect on the screen. Channel selection menu display unit 114 displays using an application including channel selection process in conjunction with a screen menu, for EPG as well as data broadcast, service list display, and others.

A digital broadcast receiving apparatus formed by optionally combining the exemplary embodiments second through fifth is practicable as well.

### INDUSTRIAL APPLICABILITY

As described above, a digital broadcast receiving apparatus having plural tuners, according to the present invention predicts a channel that the user is likely to select next time and preliminarily performs predicted channel selection process using a tuner currently not selected, thereby shortening the time from requesting channel selection by the user to switching to the channel. Consequently, the present invention is useful for a digital broadcast receiving apparatus and the like that can improve the operability in channel selection.

1. A digital broadcast receiving apparatus comprising:
a plurality of tuners that receive a digital broadcast wave;
a transport stream processing unit capable of processing at least two transport streams demodulated by the tuner;
a service information acquiring unit that extracts service information from the transport stream processing unit;
a data contents acquiring unit that caches data contents;
an audio and visual output control unit capable of processing a plurality of audio and visual data simultaneously or alternately by switching; and
a channel selection control unit that selects one tuner from among the plurality of tuners according to an instruction of channel selection from a user,
wherein the channel selection control unit preliminarily performs predicted channel selection process in which the channel selection control unit preliminarily predicts a channel that the user is likely to select next time and selects the channel using a tuner not selected out of the a plurality of tuners.

2. The digital broadcast receiving apparatus of claim 1, further comprising:
a statistical data detecting unit that detects statistical data related to reception of the digital broadcast wave,
wherein the channel selection control unit performs the predicted channel selection process according to the statistical data.

3. The digital broadcast receiving apparatus of claim 1, further comprising:
a viewing pattern detecting unit that detects a viewing pattern of the user,
wherein the channel selection control unit performs the predicted channel selection process according to the viewing pattern of the user.

4. The digital broadcast receiving apparatus of claim 1, further comprising:
a predicted channel selecting operation setting unit that sets a type of operation in which the user performs predicted channel selection; and
a predicted channel selecting operation setting detecting unit that detects channel selecting operation predicted by a type of predicted channel selecting operation, set by the predicted channel selecting operation setting unit,
wherein the channel selection control unit performs the predicted channel selection process according to the predicted channel selecting operation detected by the predicted channel selecting operation setting detecting unit.

5. The digital broadcast receiving apparatus of claim 1, further comprising:
a channel selection menu display unit that displays a menu for channel selection; and
a cursor position detecting unit that detects a position of a cursor moving on the menu for channel selection,
wherein the channel selection control unit performs the predicted channel selection process according to the position of the cursor.
